(19) United States
(12) Patent Application Publication
(10) Pub. No.: US 2021/0178421 A1
(43) Pub. Date: Jun. 17, 2021

(54) VISCOUS LIQUID DISPENSING METHOD USING THREE-DIMENSIONAL SCANNER

(71) Applicant: PROTEC CO., LTD., Gyeonggi-do (KR)

(72) Inventors: Seung Min HONG, Seoul (KR); Myoung Jin KIM, Seoul (KR)

(73) Assignee: PROTEC CO., LTD., Gyeonggi-do (KR)

(21) Appl. No.: 17/186,006

(22) Filed: Feb. 26, 2021

Related U.S. Application Data
(63) Continuation of application No. PCT/KR2019/011006, filed on Aug. 28, 2019.

(30) Foreign Application Priority Data
Aug. 29, 2018 (KR) 10-2018-0102068

(51) Int. Cl. B05C 11/10; G05B 15/02; B05C 5/02

(52) U.S. Cl. CPC B05C 11/1021; G01B 11/25; B05C 5/02; G05B 15/02

(57) ABSTRACT

The present disclosure relates to a viscous liquid dispensing method using a three-dimensional scanner, and more particularly, relates to a viscous liquid dispensing method using a three-dimensional scanner, in which a three-dimensional shape of a work, to which a viscous liquid is to be dispensed, is identified using the three-dimensional scanner, and, by using the identified result, the viscous liquid is dispensed to the work.

The viscous liquid dispensing method using a three-dimensional scanner according to the present disclosure has the effect of improving the quality of a viscous liquid dispensing process by allowing the viscous liquid to be dispensed to a correct position of the work.

According to the viscous liquid dispensing method using a three-dimensional scanner according to the present disclosure, even when there are some errors in the shape and dimension of the work, the errors can be compensated for, and thus manufacturing costs of the work can be indirectly lowered by dispensing the viscous liquid.

### CROSS-REFERENCE TO RELATED APPLICATION

This is a continuation of International Application No. PCT/KR2019/011006, filed on Aug. 28, 2019, which claims the priority benefits of Korea Application No. 10-2018-0102068, filed on Aug. 29, 2018. The entirety of each of the above-mentioned patent applications is hereby incorporated by reference herein and made a part of this specification.

### BACKGROUND

### Technical Field

The present disclosure relates to a viscous liquid dispensing method using a three-dimensional scanner, and more particularly, to a viscous liquid dispensing method using a three-dimensional scanner, allowing a three-dimensional shape of a work, to which a viscous liquid is to be dispensed, to be identified using the three-dimensional scanner, and the viscous liquid to be dispensed to the work using the identified result.

### Description of Related Art

In a semiconductor process or an electronic product manufacturing process, a process of dispensing a viscous liquid, such as an adhesive, to a correct position with a correct volume is very important. When there is an error in the dispensing position and volume of the viscous liquid, defects may occur in the product.

In particular, when the viscous liquid is dispensed to a synthetic resin work, it is important to control the dispensing position and volume. As the demand for higher specifications in products increases, the position to which the viscous liquid is dispensed and the width of the viscous liquid to be dispensed are required to be accurate enough to be processed within an error of about several tens to several hundreds of micrometers. However, in the case of a synthetic resin work, dimensional errors of several tens of micrometers or more are easily generated for each work due to the characteristics of a manufacturing process in which injection molding is used. When an injection molding work is manufactured in a very sophisticated manner to prevent such errors, there is a problem that process costs are dramatically increased.

When a viscous liquid dispensing process may be performed by considering shape or dimensional errors that may occur due to work characteristics, as in a synthetic resin work, and controlling a viscous liquid dispensing path or position while responding to such errors, a defect rate may be remarkably reduced and productivity may be improved. In particular, even in the case of a synthetic resin work, high quality and precise manufacturing are not required for the dispensing process, in such a way that manufacturing costs of the work itself may be significantly reduced.

There is a need for a viscous liquid dispensing method using a three-dimensional scanner, which is capable of accurately dispensing a viscous liquid according to the shape of each work by effectively considering errors in the individual shape and dimension of the work, to which the viscous liquid is to be dispensed, as described above.

### SUMMARY

### Technical Problem

The present disclosure is directed to providing a viscous liquid dispensing method using a three-dimensional scanner, which is capable of individually measuring the shape and dimension of a work, to which a viscous liquid is to be dispensed, and dispensing the viscous liquid to a correct position with a correct volume using the measured result.

### Solution to Problem

According to an aspect of the present disclosure, there is provided a viscous liquid dispensing method using a three-dimensional scanner, in which a viscous liquid is dispensed to a work by using a pump, the method comprising (a) obtaining three-dimensional shape data for an area of a work, to which the viscous liquid is to be dispensed, and surroundings of the area by scanning at least a portion of the work with a three-dimensional scanner, (b) calculating, by a control unit, a dispensing path to which the viscous liquid is to be dispensed using the three-dimensional shape data for the work obtained in step (a), and (c) dispensing the viscous liquid to the work while moving the pump along the dispensing path, which is calculated by the control unit in step (b), using a pump moving unit.

### Advantageous Effects

A viscous liquid dispensing method using a three-dimensional scanner according to the present disclosure has the effect of improving the quality of a viscous liquid dispensing process by allowing a viscous liquid to be dispensed to a correct position of a work.

A viscous liquid dispensing method using a three-dimensional scanner according to the present disclosure has the effect of indirectly lowering manufacturing costs of a work even when there are some errors in the shape and dimension of the work by dispensing a viscous liquid using a method that can compensate for the errors.

### BRIEF DESCRIPTION OF THE DRAWINGS

FIG. 1 is a configuration diagram of a dispenser that is used for implementing an example of a viscous liquid dispensing method using a three-dimensional scanner according to the present disclosure.

FIG. 2 is a diagram illustrating an example of a work to which a viscous liquid is to be dispensed by the viscous liquid dispensing method using a three-dimensional scanner according to an embodiment of the present disclosure.

FIGS. 3 and 4 are cross-sectional views taken along line III-III and line IV-IV, respectively, for partial areas of the work shown in FIG. 2.

### DESCRIPTION OF THE EMBODIMENTS

Hereinafter, an example of a viscous liquid dispensing method using a three-dimensional scanner according to the present disclosure will be described with reference to the accompanying drawings.

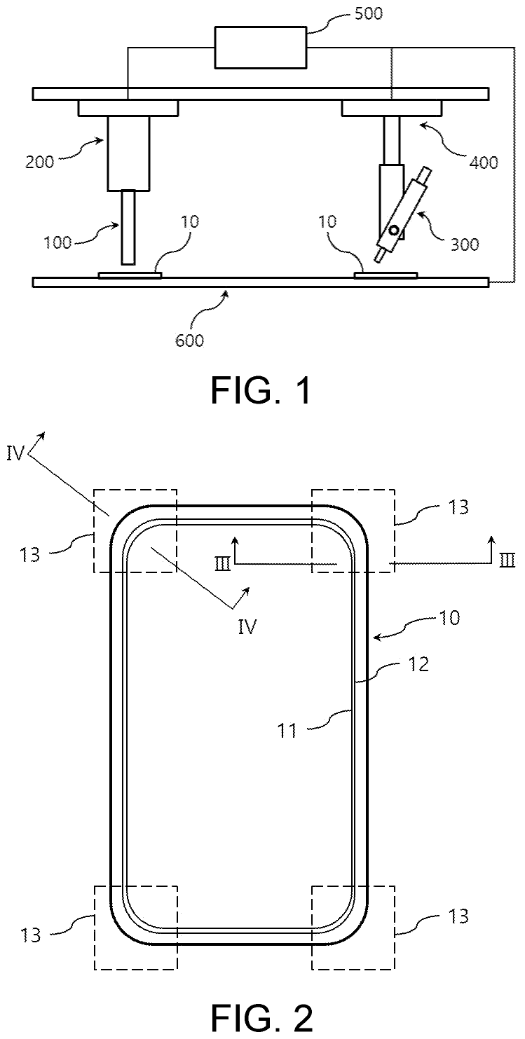

FIG. 1 is a configuration diagram of a dispenser that is used for implementing an example of the viscous liquid dispensing method using a three-dimensional scanner according to the present disclosure, and FIG. 2 is a diagram illustrating an example of a work to which a viscous liquid is to be dispensed by the viscous liquid dispensing method using a three-dimensional scanner according to an embodiment of the present disclosure.

First, the configuration of the dispenser, which is used for implementing an example of the viscous liquid dispensing method using a three-dimensional scanner according to the present disclosure, will be described with reference to FIG. 1.

A work 10 having a shape as shown in FIG. 2 is supplied by being placed on a work transfer unit 600. The work transfer unit 600 transfers the work 10 in a horizontal direction.

A three-dimensional scanner 100 and a pump 300 are disposed above the work transfer unit 600.

The three-dimensional scanner 100 is moved in the horizontal direction and a vertical direction by a scanner moving unit 200. When the scanner moving unit 200 moves the three-dimensional scanner 100 to a position close to a major part of the work 10, the three-dimensional scanner 100 scans the work 10 and obtains three-dimensional shape data for the work 10. Various known configurations may be used for the three-dimensional scanner 100. In the present embodiment, a case will be described as an example, in which the three-dimensional scanner 100 obtains a three-dimensional shape of a corresponding area by capturing an image of the work 10 at high speed using a digital micromirror device (DMD) with digital light processing (DLP) technology.

When the scanner moving unit 200 moves the three-dimensional scanner 100 to a position at which three-dimensional shape data needs to be obtained, the three-dimensional scanner 100 scans the work 10 three-dimensionally and obtains the three-dimensional shape data.

When the three-dimensional scanning for the work 10 is completed, the work transfer unit 600 transfers the work 10 to a space below the pump 300.

A pump moving unit 400 moves the pump 300 in the horizontal direction and the vertical direction with respect to the work 10 on the basis of the three-dimensional shape data, and the pump 300 dispenses the viscous liquid through a nozzle. In the case of the present embodiment, the pump moving unit 400 controls an angle of the pump 300 with respect to the work 10 by tilting the pump 300.

A control unit 500 controls operations of the three-dimensional scanner 100, the pump 300, the scanner moving unit 200, the pump moving unit 400, and the work transfer unit 600.

Hereinafter, a process of dispensing a viscous liquid to the work 10 by the viscous liquid dispensing method using the three-dimensional scanner 100 of the present embodiment, in which the dispenser configured as described above is used, will be described.

In the present embodiment, a process of dispensing an epoxy adhesive as the viscous liquid to a synthetic resin injection-molded work having a quadrangular frame shape as shown in FIG. 2 will be described.

In the case of the work 10 having a form of a synthetic resin injection-molded work, dimensional and shape errors of several tens of micrometers or more are easily generated due to characteristics of a synthetic resin and characteristics of an injection molding process. In addition, even in injection-molded works manufactured by the same process using the same mold, each work 10 is often slightly different in size and shape.

A process of dispensing a viscous liquid to the work 10 having the above-described form will be described.

First, at least a portion of the work 10 is scanned by the three-dimensional scanner 100 to obtain three-dimensional shape data for an area, to which the viscous liquid is to be dispensed, and surroundings of the area (step (a)).

The work 10 is placed below the three-dimensional scanner 100 by the work transfer unit 600. The area to which the viscous liquid is to be dispensed and an area around the area are scanned three-dimensionally by the three-dimensional scanner 100 while moving the three-dimensional scanner 100 with the scanner moving unit 200. All areas to which the viscous liquid is to be dispensed may be three-dimensionally scanned or only a partial area may be three-dimensionally scanned. When DMD technology is used, hundreds of images or more are captured in one second to obtain the three-dimensional shape data, and thus a very fast operation is possible. The process of obtaining the three-dimensional shape data is performed only for a partial area of the work 10 in order to further increase the operation speed. In the case of the present embodiment, a case in which three-dimensional scanning is performed only on four corner portions 13 (as shown in dotted lines in FIG. 2) of the work 10 having a quadrangular frame shape will be described as an example.

The change in shape at the four corner portions 13 of the work 10 is relatively large due to the injection molding process. Since the result of dispensing the viscous liquid in these portions greatly affects the quality of the entire process, three-dimensional scanning is performed on the quadrangular corner portions.

The three-dimensional shape data obtained by the three-dimensional scanner 100 is transmitted to the control unit 500. The control unit 500 calculates a dispensing path in which the viscous liquid is to be dispensed using the three-dimensional shape data for the work 10 obtained in step (a) (step (b)).

The control unit 500 may calculate the dispensing path using various methods. Various dispensing path calculation methods according to the structure and characteristics of the work 10 are programmed and performed by the control unit 500.

In the present embodiment, the control unit 500 calculates the dispensing path using an edge shape of the work 10. The control unit 500 extracts portions of edges 11 and 12, at which surfaces meet, from the shape of the work 10 using the shape data obtained by the three-dimensional scanner 100. The dispensing path may also be calculated along paths of the edges. For example, it is possible to set a path maintaining a reference distance inward with respect to an outer edge 12, among the edges 11 and 12 of the work 10 shown in FIGS. 2 to 4, as the dispensing path. For example, the control unit 500 may set a point away from the outer edge 12 inward by 1 mm to be the dispensing path. Alternatively, it is possible for the control unit 500 to extract an inner edge 11 and the outer edge 12 of the work 10 shown in FIGS. 2 to 4 and calculate a point between the two edges 11 and 12 as the dispensing path. In the case of the present embodiment, a case in which the control unit 500 sets an intermediate point that is a half of a width W between the inner edge 11 and the outer edge 12 as the dispensing path will be described as an example. In addition to the above-described method, the control unit 500 may calculate the dispensing path in various ways according to the characteristics of the work 10 and needs in the process.

When the control unit 500 completes the calculation of the dispensing path for the four corner portions 13 of the work 10 having a quadrangular frame shape as described above, the control unit 500 may also calculate a dispensing path for the remaining portions of the work 10. When errors in shapes of portions corresponding to four sides are not great unlike the four corner portions 13 of the quadrangular frame, the control unit 500 may set a dispensing path corresponding to the four sides using the shape data for the work 10 stored in advance. It is also possible for the control unit 500 to set a dispensing path numerically corresponding to the four sides by a method of connecting dispensing paths for the four corner portions 13. In this case, end portions of the dispensing paths of the four corner portions 13 may be connected by a straight line or a curved line reflecting a predetermined curvature, or it is also possible to set the dispensing path by interpolating a section between the end portions using the shape data for the four corner portions 13. The control unit 500 may calculate a dispensing path for a section between areas scanned by the three-dimensional scanner 100 in various ways as described above.

Meanwhile, the control unit 500 may three-dimensionally calculate a dispensing path. That is, the control unit 500 considers the height of the work 10 along a dispensing path in addition to a path moving on a plane and calculates the dispensing path, through which the nozzle of the pump 300 passes, in such a way that three-dimensional coordinates are connected.

As described above, when the calculation of the dispensing path by the control unit 500 is completed, in response to the command of the control unit 500, the pump 300 dispenses a viscous liquid to the work 10 while being moved along the dispensing path by the pump moving unit 400 (step (c)). At this point, the control unit 500 controls such that the pump 300 dispenses the viscous liquid to the work 10 while being moved three-dimensionally by the pump moving unit 400 in such a way that a distance between the nozzle of the pump 300 and the work 10 is maintained constant. Accordingly, the distance between the nozzle and a surface of the work 10 to which the viscous liquid is dispensed is maintained constant, thereby improving the quality of a dispensing process.

When an angle between the nozzle of the pump 300 and the surface of the work 10 is maintained as a right angle by the pump moving unit 400 in performing the process of dispensing the viscous liquid to the work 10 as described above, the quality of the dispensing process may be further improved.

To this end, a process of obtaining information about an angle of the surface of the work 10 along the dispensing path is required. When the dispensing path is calculated in step (b), the control unit 500 calculates an angle of the surface of the work 10 at a position corresponding to the dispensing path using the shape data for the work 10 obtained in step (a) (step (d)). In the case in which only a portion of the work 10 is three-dimensionally scanned as described above, the dispensing path between the scanned areas is numerically calculated by a method such as using reference shape data for the work 10 stored in advance or interpolating the angle of the surface of the work 10 calculated in the scanned area.

In the case in which the control unit 500 calculates the angle of the surface of the work 10 in step (d) as described above, when the viscous liquid is dispensed in step (c), the viscous liquid is dispensed while controlling the angle of the pump 300 by the pump moving unit 400 in such a way that the angle between the nozzle of the pump 300 and the surface of the work 10 is maintained as a right angle. It is preferable that the viscous liquid is dispensed in a state in which the nozzle of the pump 300 and the surface of the work 10 are perpendicular to each other, but in some cases, it is also possible to dispense the viscous liquid while maintaining an angle other than 90° constant.

As described above, according to the present disclosure, since the dispensing may be performed while controlling the angle of the pump 300 according to the angle of the surface of the work 10, it is possible to dispense a viscous liquid to a correct position with a correct volume even for the work 10 formed to have a three-dimensional curved surface, and even when there are dimensional errors, shape errors, and processing errors on the surface of the work 10, on which the dispensing is performed, by considering these errors, the viscous liquid dispensing process may be accurately performed. In addition, even in a case in which the work transfer unit 600 on which the work 10 is placed or a work mounting tray which is disposed between the work 10 and the work transfer unit 600 is inclined, when the viscous liquid is dispensed in consideration of the angle of the work 10 as described above, the quality of the dispensing process may be improved.

As described above, when the shape data for the work 10 is obtained by the three-dimensional scanner 100 in step (a), it is also possible for the pump 300 to dispense the viscous liquid while changing the dispensing volume along the dispensing path by considering the shape of the work 10.

To this end, the control unit 500 calculates a dispensing amount of the viscous liquid to be dispensed to the work 10 along the dispensing path, which is calculated in step (b), before step (c) is performed (step (e)).

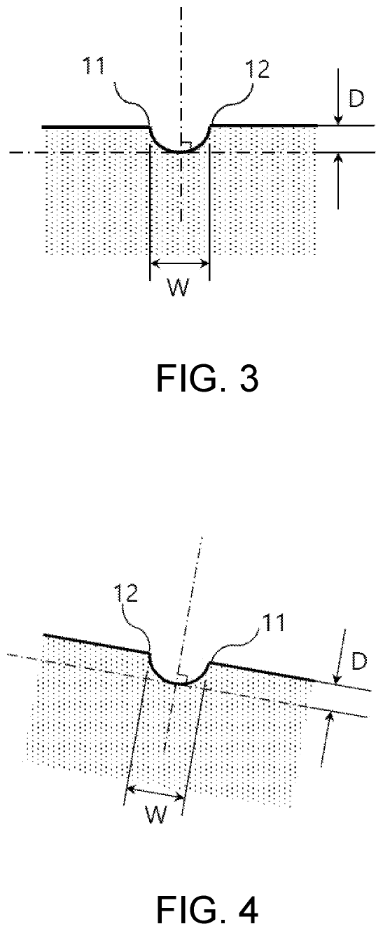

For example, the control unit 500 may calculate the dispensing amount of the viscous liquid in a manner of calculating the width W and a depth D of a space between the two edges 11 and 12 of the work 10 as shown in FIGS. 3 and 4, increasing the dispensing amount when the width W and the depth D are greater than reference values, and decreasing the dispensing amount when the width W and the depth D are less than the reference values.

As described above, in the case in which the control unit 500 calculates the dispensing amount of the viscous liquid in step (e), when step (c) is performed, the viscous liquid is dispensed as much as the calculated dispensing amount of the viscous liquid.

As a typical method of controlling the dispensing amount of the viscous liquid, a method of fixing one of a moving velocity of the pump 300 and a flow rate of the viscous liquid, which is dispensed through the nozzle of the pump 300, and controlling the remaining one thereof is used. In the case of the present embodiment, a method of fixing the moving velocity of the pump 300 and controlling the flow rate of the viscous liquid dispensed by the pump 300 is used. The flow rate of the viscous liquid dispensed through the nozzle is controlled by moving the pump 300 at a constant velocity using the pump moving unit 400. When the piezoelectric pump 300 is used, the flow rate of the viscous liquid may be controlled by controlling a period, in which a valve rod of the piezoelectric pump 300 is raised and lowered, by the control unit 500.

As described above, various advantages may be obtained by differently controlling the amount of viscous liquid dispensed for each work 10 in consideration of the shape data for the work 10. The process costs of processing or manufacturing the work 10 may be reduced. Even when the dimension accuracy of the work 10 is not high, the viscous liquid is dispensed in consideration of the actual shape and dimension of the work 10 in the operation of dispensing the viscous liquid, in such a way that it is possible to reduce costs required for the manufacturing process of the work 10 for manufacturing the work 10 with high accuracy. Even for the work 10 to be treated as a defective work because there is an error in the dimension and shape of the work 10, by dispensing the viscous liquid in consideration of such dimensional or shape error, it is possible to treat the work 10 as a good work without treating the work 10 as a defective work in the process. In this way, the yield of the entire product manufacturing process may be improved.

For example, it may be impossible for another part to adhere to the work 10 due to a shape error of the work 10, or even when the adhesion is made, the adhesion between the work 10 and the part may not be achieved in some sections, and a gap may be generated between the work 10 and the part, but even in this case, by additionally dispensing and curing an adhesive in consideration of the shape error of the work 10, the gap that may be generated between the work 10 and the part may be filled with the adhesive, thereby preventing defects.

Even when the position and direction of the pump 300 are controlled and the dispensing amount is controlled in consideration of the three-dimensional shape of the work 10 as described above, in some cases, it may be sometimes difficult to accurately control the volume of the dispensed viscous liquid. In general, as time passes and temperature changes, characteristics of the viscous liquid change and operating characteristics of the pump 300 also change, and thus an error may exist in the dispensing result even when the dispensing is performed with the same viscous liquid and pump 300.

In this case, as will be described below, the error may be corrected through a method of inspecting the dispensing result using the three-dimensional scanner 100 to determine whether there is a defect, and adding the dispensing amount of the viscous liquid with the pump 300 when the dispensed amount of the viscous liquid is insufficient.

When the process of dispensing the viscous liquid to the work 10 is completed through step (c), the work transfer unit 600 transfers the work 10 to the space below the three-dimensional scanner 100 again. The scanner moving unit 200 moves the three-dimensional scanner 100 to the area of the work 10, to which the viscous liquid is dispensed, and the three-dimensional scanner 100 scans the result of dispensing of the viscous liquid performed in step (c) and obtains three-dimensional shape data for the work 10 to which the viscous liquid is dispensed (step (0).

The control unit 500 inspects the result of dispensing of the viscous liquid performed in step (c) using the three-dimensional shape data obtained in step (0 (step (g)).

When it is determined that the dispensing amount is insufficient as a result of inspecting the result of dispensing of the viscous liquid while performing step (g), the control unit 500 calculates a dispensing path to which the viscous liquid is to be added and a dispensing amount.

The work transfer unit 600 transfers the work 10 to the space below the pump 300 again, and the control unit 500 additionally dispenses the viscous liquid to the work 10 according to the result of step (g) while moving the pump 300 using the pump moving unit 400 (step (h)).

In this manner, the result of dispensing of the viscous liquid may be inspected by the three-dimensional scanner 100, or in some cases, the dispensing amount of the viscous liquid may be corrected. In this manner, the quality of the dispensing process may be further improved, and also, the defect rate may be reduced.

In some cases, it is also possible to perform the viscous liquid dispensing method using the three-dimensional scanner 100 of the present disclosure in a manner of dispensing the viscous liquid less than a set volume while performing step (c), and then sequentially performing the steps (f), (g), and (h) to more accurately control the dispensing volume of the viscous liquid.

Although the present disclosure has been described with reference to the preferred examples, the scope of the present disclosure is not limited to the form described and illustrated above.

For example, it was previously described that only four corners of the work 10 having a quadrangular frame shape are scanned with the three-dimensional scanner 100 in step (a) and the space between the scanned areas is calculated numerically, but in some cases, it is also possible to obtain three-dimensional shape data by performing step (a) for all areas along the dispensing path.

Further, it was previously described that the angle of the surface of the work 10 is calculated in step (d) and the dispensing is performed while controlling the angle of the pump 300 in consideration of the angle of the surface of the work 10, but in some cases, depending on the characteristics of the work 10, it is also possible to perform step (c) while fixing the angle of the pump 300 without considering such an angle.

Further, it was previously described that the dispensing path is calculated using the edges 11 and 12 of the work 10, but it is also possible to calculate the dispensing path using criteria other than edges. For example, a line that will be a reference of the dispensing path may be previously marked on the work 10 using a laser or the like, and the control unit 500 may calculate the dispensing path on the basis of the line. In step (b), the control unit 500 may calculate the dispensing path using various methods other than the above-described methods in consideration of the characteristics of the work 10.

Further, it was previously described that the process of three-dimensional scanning and inspecting the dispensing result is performed in the steps (f) and (g), and the process of additionally dispensing is performed in step (h), but it is also possible to perform a viscous liquid dispensing method using the three-dimensional scanner 100, in which the steps (0 to (h) are not performed.

Meanwhile, a portion corresponding to the corner of the quadrangular frame and a portion at which surfaces meet at four sides of the quadrangular frame were described by expressing as the corner and the edge, respectively, for classification.

What is claimed is:

1. A viscous liquid dispensing method using a three-dimensional scanner, in which a viscous liquid is dispensed to a work by using a pump, the method comprising:
(a) obtaining three-dimensional shape data for an area of the work, to which the viscous liquid is to be dispensed, and surroundings of the area by scanning at least a portion of the work with a three-dimensional scanner;
(b) calculating, by a control unit, a dispensing path to which the viscous liquid is to be dispensed using the three-dimensional shape data for the work obtained in step (a); and
(c) dispensing the viscous liquid to the work by the pump while moving the pump along the dispensing path, which is calculated by the control unit in step (b), using a pump moving unit.

2. The method of claim 1, wherein
in step (a), the three-dimensional shape data is obtained by scanning a plurality of areas of the work using the three-dimensional scanner; and
in step (b), the control unit calculates the dispensing path for the area scanned by the three-dimensional scanner and the dispensing path connecting between the areas scanned by the three-dimensional scanner.

3. The method of claim 1, wherein, in step (b), the control unit extracts an edge of the work at a position adjacent to the dispensing path using the three-dimensional shape data for the work, which is obtained in step (a), and calculates the dispensing path on the basis of the extracted edge.

4. The method of claim 1, wherein, in step (b), the control unit extracts two edges at positions adjacent to the dispensing path using the three-dimensional shape data for the work, which is obtained in step (a), and calculates the dispensing path using a point between the two edges.

5. The method of claim 1, wherein
in step (b), the control unit calculates the dispensing path as a three-dimensional path in consideration of a height of an area of the work, to which the viscous liquid is to be dispensed, and
in step (c), the viscous liquid is dispensed to the work while moving the pump three-dimensionally using the pump moving unit in such a way that a distance between a nozzle of the pump and the work is maintained constant along the dispensing path calculated in step (b).

6. The method of claim 5, further comprising,
(d) calculating, by the control unit, an angle of a surface of the work along the dispensing path calculated in step (b);
wherein, in step (c), the viscous liquid is dispensed to the work while controlling an angle of the pump using the pump moving unit in such a way that an angle between a direction of the surface of the work calculated in step (d) and a direction of the nozzle of the pump is maintained constant.

7. The method of claim 5, further comprising an step (e) of calculating, by the control unit, a dispensing amount of the viscous liquid to be dispensed to the work along the dispensing path that is calculated in step (b),
wherein in step (c), the viscous liquid is dispensed while controlling at least one of a moving velocity of the pump, which is controlled by the pump moving unit, and a flow rate of the viscous liquid dispensed through the nozzle of the pump, in such a way that the viscous liquid is dispensed to the work according to the dispensing amount calculated in step (e).

8. The method of claim 5, further comprising:
(f) obtaining three-dimensional shape data for the work, to which the viscous liquid is dispensed, by scanning a result of dispensing of the viscous liquid in step (c) using the three-dimensional scanner; and
(g) inspecting, by the control unit, a result of dispensing of the viscous liquid, which is performed in step (c), using the three-dimensional shape data obtained in step (f).

9. The method of claim 8, wherein
in step (g), when it is determined that the dispensing amount is insufficient as a result of inspecting the result of dispensing of the viscous liquid, a dispensing path to which the viscous liquid is to be added and a dispensing amount are calculated, and
according to a result of step (g), the method further comprises,
(h) additionally dispensing the viscous liquid to the work while moving the pump using the pump moving unit.
